(19) United States
(12) Patent Application Publication
(10) Pub. No.: US 2016/0130779 A1
(43) Pub. Date: May 12, 2016

(54) AN ASSEMBLY OF A TOWER AND A MONOPILE

(71) Applicant: IHC HYDROHAMMER B.V., Sliedrecht (NL)

(72) Inventor: Jakob Van Dijk, Den Haag (NL)

(21) Appl. No.: 14/893,050

(22) PCT Filed: May 13, 2014
(86) PCT No.: PCT/NL2014/050299

§ 371 Date: Nov. 20, 2015

(30) Foreign Application Priority Data
May 23, 2013 (NL) 2010845

(51) Int. Cl. E02D 27/42; E04H 12/00

(52) U.S. Cl. CPC E02D 27/425; E04H 12/00; F03D 11/045

(57) ABSTRACT

An assembly of a tower for supporting a wind turbine and a tubular monopile to be driven into a seabed. The monopile is provided with a monopile flange that extends radially from a circumferential wall of the monopile. It has a monopile flange surface for supporting the tower. The monopile comprises an impact portion for receiving strikes of an anvil. The impact portion extends at a side of the monopile flange surface in radial direction thereof. The tower and the monopile are shaped such that at the impact portion a distance is present between the tower and the monopile in longitudinal direction of the monopile as well as in radial direction thereof at the side of the monopile flange surface when the monopile supports the tower.

### CROSS-REFERENCE TO RELATED APPLICATION

The present application is a national stage filing of International patent application Serial No. PCT/NL2014/050299, filed May 13, 2014, and published as WO 2014/189367 A1 in English.

### BACKGROUND

The discussion below is merely provided for general background information and is not intended to be used as an aid in determining the scope of the claimed subject matter.

The present invention pertains to an assembly of a tower for supporting a wind turbine and a tubular monopile to be driven into a seabed, the monopile being provided with a monopile flange extending radially from a circumferential wall of the monopile and having a monopile flange surface for supporting the tower, wherein the monopile comprises an impact portion for receiving strikes of an anvil, which impact portion extends at a side of the monopile flange surface in radial direction thereof.

The operating costs for offshore heavy lift equipment to install the monopile and the tower are relatively high. Therefore, it is desired to mount the tower onto the monopile as soon as possible after the monopile has been driven into the seabed. The idle time of the lift equipment is reduced when the monopile is already provided with a flanged structure before driving it into the seabed. However, large accelerations in the monopile during driving the monopile by a hydraulic hammer may lead to deformations of the monopile and decrease of the fatigue life of the monopile, even if the anvil strikes onto the impact portion and not directly onto the monopile flange surface itself.

### SUMMARY

The Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the present invention is to provide a simple assembly of a tower and a monopile which allows a rapid assembling process.

This is achieved by the assembly, which is characterized in that the tower and the monopile are shaped such that at the impact portion a distance is present between the tower and the monopile in longitudinal direction of the monopile as well as in radial direction thereof at the side of the monopile flange surface when the monopile supports the tower.

This means that the impact portion is allowed to deform during driving the monopile into the seabed, whereas the tower can be mounted onto the monopile by placing it onto the monopile flange surface thereof without being hindered by deformations of the impact portion at the side of the monopile flange surface or at the top thereof. This provides the opportunity to mount the tower onto the monopile soon after driving the monopile into the seabed, eliminating additional work steps.

In practice, the impact portion may be located above the tubular portion of the monopile in order to effectively transfer the impact load to the lower portion of the monopile.

The tower and the monopile may be shaped such that there is also a distance between the tower and the monopile in radial direction of the monopile at a side of the impact portion opposite to the monopile flange surface when the monopile supports the tower. This means that in assembled condition the tower is free from the monopile at opposite sides of the impact portion in radial direction of the monopile.

Preferably, the monopile is provided with a sealing portion for supporting the tower together with the monopile flange surface, which sealing portion extends at a side of the impact portion opposite to the flange surface. In assembled condition of this embodiment the tower rests on the monopile flange surface as well as on the sealing portion. As a consequence, a space between the tower and the monopile at the impact portion is substantially sealed with respect to the environment. This minimizes the risk of corrosion of the tower and/or the monopile.

A space created by the distance between the tower and the monopile at the impact portion may be filled with a corrosion-resistant substance. This prevents at least the impact portion from corrosion after damaging and/or deforming the impact portion during driving the monopile into the seabed.

In a practical embodiment the monopile has a circular cross-section and the impact portion is located concentrically with respect to the circumferential wall of the monopile. In case of the presence of a sealing portion as described hereinbefore, the sealing portion may also be located concentrically with respect to the circumferential wall of the monopile.

In a preferred embodiment the monopile flange extends inwardly from the circumferential wall of the monopile since this minimizes protruding parts at the outside of the assembled tower and monopile. The flange may extend along the inner circumference of the monopile. Furthermore, in case of the presence of a sealing portion as described hereinbefore, the sealing portion may extend up to an outer surface of the circumferential wall of the monopile. This provides the opportunity to create a smooth transition of the outer surfaces of the monopile and the tower in assembled condition.

The tower may also be tubular and provided with a tower flange that fits to the monopile flange. The flanges can be fixed to each other by means of bolts, for example.

In case of the presence of a sealing portion as described hereinbefore, the impact portion may comprise an elevation between the monopile flange surface and the sealing portion, wherein the tower comprises a recess for accommodating the elevation. The monopile flange surface and the sealing portion may extend in a substantially flat plane that extends perpendicularly to a centre line of the monopile, whereas the impact portion may project from the plane. It is noted that in a practical embodiment the monopile flange surface may be slightly inclined with respect to the flat plane away from the upper end of the monopile as seen from the circumferential wall thereof, for example at an angle of 1°.

The distance between the monopile flange surface and the impact portion in longitudinal direction of the monopile may be smaller than the thickness of the monopile flange, and preferably smaller than half of the thickness thereof. The distance may even be smaller than 15% of the thickness of the monopile flange. An advantage of the limited distance is that a flange portion can be manufactured relatively easy by machining a ring-shaped element and cutting the sealing portion and the monopile flange surface such that the impact portion remains as a concentrical elevation above and between the sealing portion and the monopile flange surface, after which the resulting flange portion can be welded to an end of a tubular monopile portion.

### BRIEF DESCRIPTION OF THE DRAWINGS

Aspect of the invention will hereafter be elucidated with reference to drawings illustrating an embodiment of the invention very schematically.

FIG. 1 is a side view of an offshore wind turbine system comprising an embodiment of an assembly of a tower and a monopile.

FIG. 2 is an enlarged cross-sectional view of a part of the embodiment of FIG. 1 as indicated by II therein.

FIG. 3 is a similar view as FIG. 2, illustrating an upper portion of the monopile separately.

### DETAILED DESCRIPTION OF ILLUSTRATIVE EMBODIMENTS

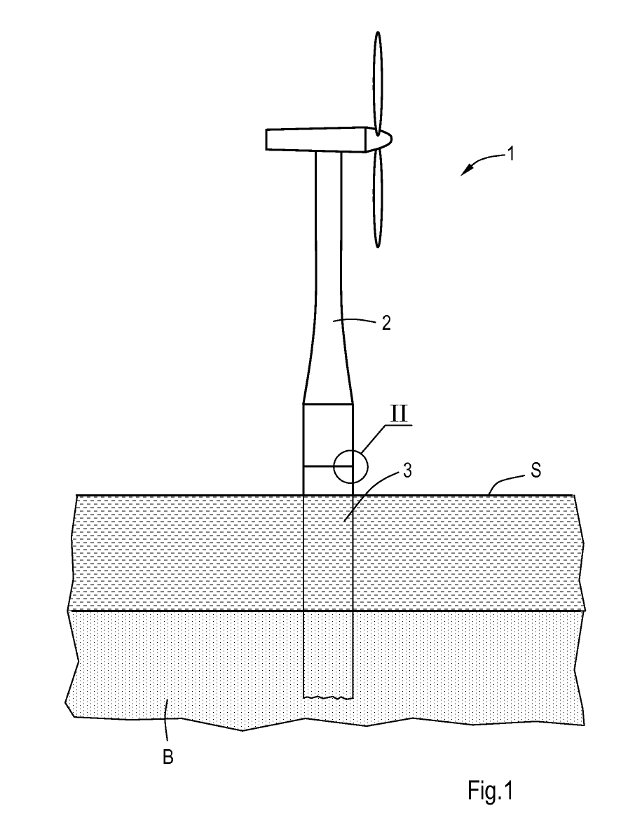

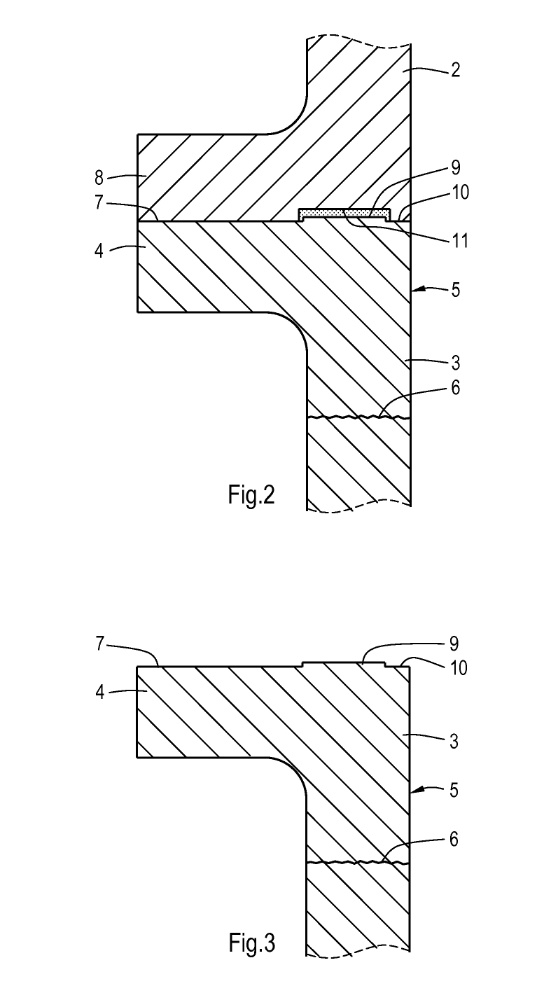

FIG. 1 shows an offshore wind turbine system 1, which is supported in the sea bed B and rises above the sea level S. The wind turbine system 1 comprises an assembly of a tower 2 for supporting a wind turbine and a tubular monopile 3 to be driven into the seabed B. In the assembled condition as shown in FIG. 1 the monopile 3 forms a foundation or substructure for the tower 2. The monopile 3 generally comprises a cylindrical steel pipe which is driven by a hydraulic hammer (not shown) into the seabed B to a predetermined depth. After the monopile 3 has been driven into the seabed B an upper end portion of the monopile 3 projects above the sea level S and subsequently the tower 2 is mounted thereon. A part of the transition between the monopile 3 and the tower 2 in assembled condition is illustrated in FIG. 2, whereas a part of the upper end portion of the monopile 3 is shown in FIG. 3.

The monopile 3 is provided with a monopile flange 4 which extends radially inwardly from a circumferential wall of the monopile 3. In the embodiment as shown in FIGS. 2 and 3 the monopile flange 4 is part of a flange portion 5 which is welded to an upper end of a tubular monopile portion at a weld seam 6. The monopile flange 4 has a monopile flange surface 7 for supporting the tower 2. The monopile flange surface 7 extends substantially perpendicularly to the centre line of the monopile 3 and is directed away from the monopile 3. In the embodiment as shown in FIG. 2 the tower 2 is also tubular and provided with a tower flange 8. The tower flange 8 may be welded to a lower end of a tubular tower portion. The monopile flange 4 and the tower flange 8 fit to each other such that the monopile flange surface 7 supports the tower flange 8 in assembled condition. The tower 2 may be attached to the monopile 3 by means of fixing the tower flange 8 and the monopile flange 4 to each other, for example through bolts which pass through holes in the flanges 4, 8.

The upper surface of the monopile 3 that is directed to the tower 2 also comprises an impact portion 9 for receiving strikes of an anvil (not shown) during driving the monopile 3, and a sealing portion 10 for supporting the tower 2 together with the monopile flange surface 7. The impact portion 9 extends concentrically with respect to the monopile flange surface 7 at an outer circumference thereof and the sealing portion 10 also extends concentrically with respect to the monopile flange surface 7 at a side of the impact portion 9 opposite to the monopile flange surface 9. In this case the impact portion 9 forms an elevation between the monopile flange surface 7 and the sealing portion 10. This allows to use an anvil having a flat lower surface, since the elevated impact portion 9 prevents the anvil from touching the monopile flange surface 7 and the sealing portion 10 during striking onto the monopile 3. The elevation may be such that the distance between the monopile flange surface 7 and the impact portion 9 in longitudinal direction of the monopile 3 is smaller than 20% of the thickness of the monopile flange 4, for example 3-5 mm, but a smaller or larger distance is conceivable.

FIG. 2 shows that a lower side of the tower 2 comprises a recess 11 for accommodating the elevation at the impact portion 9 in the assembled condition. The recess 11 is shaped such that at the impact portion 9 there is a distance between the tower 2 and the monopile 3 in longitudinal direction of the monopile 3 as well as in radial direction thereof at opposite sides of the impact portion 9. This avoids a situation that any deformation at the impact portion 9 may form an obstruction for the fitting of the tower 2 on the monopile 3 at the monopile flange surface 7 and the sealing surface 10.

The surfaces of the monopile 3 may be coated with a protecting coating before driving the monopile 3 into the seabed B, for example a metallic coating. This may be performed onshore. After the monopile 3 has been installed the impact portion 9 may be damaged and any protecting coating on the impact portion 9, if present, may be removed. Therefore, the space created between the impact portion 9 and the tower 2 at the recess 11 is filled with a corrosion-resistant substance.

In the assembled condition as shown in FIG. 2 there is a smooth transition between the tower 2 and the monopile 3 at their outer surfaces. The sealing portion 10 extends up to the outer surface of the circumferential wall of the monopile 3, such that an appropriate seal is obtained in order to avoid penetration of air and/or water between the tower 2 and the monopile 3.

The invention is not limited to the embodiment as shown in the drawings and described hereinbefore, which may be varied in different manners within the scope of the claims.

1. An assembly of a tower for supporting a wind turbine and a tubular monopile to be driven into a seabed, the monopile being provided with a monopile flange extending radially from a circumferential wall of the monopile and having a monopile flange surface configured to support the tower, wherein the monopile comprises an impact portion configured to receive strikes of an anvil, which impact portion extends at a side of the monopile flange surface in radial direction thereof, wherein the tower and the monopile are shaped such that at the impact portion a distance is present between the tower and the monopile in longitudinal direction of the monopile as well as in radial direction thereof at the side of the monopile flange surface when the monopile supports the tower.

2. The assembly according to claim 1, wherein the tower and the monopile are shaped such that there is also a distance between the tower and the monopile in radial direction of the monopile at a side of the impact portion opposite to the monopile flange surface when the monopile supports the tower.

3. The assembly according to claim 2, wherein the monopile is provided with a sealing portion configured to support the tower together with the monopile flange surface, which sealing portion extends at a side of the impact portion opposite to the monopile flange surface.

4. The assembly according to claim 1, wherein a space created by the distance between the tower and the monopile at the impact portion is filled with a corrosion-resistant substance.

5. the assembly according to claim 1, wherein the monopile has a circular cross-section and the impact portion is located concentrically with respect to the circumferential wall of the monopile.

6. The assembly according to claim 1, wherein the monopile flange extends inwardly from the circumferential wall of the monopile.

7. The assembly according to claim 3, wherein the sealing portion extends up to an outer surface of the circumferential wall of the monopile.

8. The assembly according to claim 1, wherein the tower is tubular and provided with a tower flange that fits to the monopile flange.

9. The assembly according to claim 1, wherein the monopile flange is part of a flange portion which is welded to an upper end of a tubular monopile portion.

10. The assembly according to claim 1, wherein the impact portion comprises an elevation between the monopile flange surface and the sealing portion, wherein the tower comprises a recess for accommodating the elevation.

11. The assembly according to claim 1, wherein the distance between the monopile flange surface and the impact portion in longitudinal direction of the monopile is smaller than the thickness of the monopile flange, and preferably smaller than half of the thickness thereof.

12. The assembly according to claim 1, wherein the distance between the monopile flange surface and the impact portion in longitudinal direction of the monopile is smaller than half of the thickness thereof.
